(19) United States
(12) Patent Application Publication
(10) Pub. No.: US 2011/0072952 A1
(43) Pub. Date: Mar. 31, 2011

(54) TREMOLO DEVICE OF AN ELECTRIC GUITAR AND METHOD OF PRODUCING TREMOLO AND ELECTRONIC SOUND EFFECTS USING THE SAME

(75) Inventors: ATSUSHI KOYAMA, Yokohama (JP); Yoshihiro Murakami, Hong Kong (HK)

(73) Assignee: eBridge Limited

(21) Appl. No.: 12/889,408

(22) Filed: Sep. 24, 2010

(30) Foreign Application Priority Data
Sep. 29, 2009 (HK) 09109027.9

(51) Int. Cl. G10D 3/00

(52) U.S. Cl. 84/313

(57) ABSTRACT

A tremolo device of an electric guitar includes an inertia block or tremolo bridge plate for attachment to the guitar and having a bore therethrough, an arm attached at a proximal end thereof to the inertia block or tremolo bridge plate, a potentiometer and/or a switch located at a distal end of the arm for controlling electrical functions of the guitar and/or associated amplifier, and one or more wires extending from the potentiometer and/or switch through the arm and passing through the bore of the inertia block or tremolo bridge plate for connection to circuitry within the guitar.

### CROSS-REFERENCE TO RELATED APPLICATIONS

This application claims priority of Hong Kong Short-Term Patent Application No. 09109027.9 filed on 29 Sep. 2009, the entire content of which is hereby incorporated by reference.

### FIELD OF INVENTION

The invention generally relates to a tremolo device, and particularly relates to a tremolo arm (also known as a “tremolo bar” or “whammy bar”) which is typically attached to the bridge or tailpiece of an electric guitar.

The invention also relates to a method of producing tremolo and electronic sound effects using the tremolo device of an electric guitar.

### BACKGROUND

Tremolo arms enable the player to vary the tension and length of the strings while playing to alter the pitch and create a vibrato, portamento or pitch-bend effect.

Electric guitars and their amplifiers also have switches and potentiometers to control volume and tone for example, but these are positioned remotely of the tremolo arm which itself is usually conveniently positioned adjacent to the bridge. Therefore control of the switches and potentiometers during play is inconvenient.

The above description of the background is provided to aid in understanding a tremolo device of an electric guitar, but is not admitted to describe or constitute pertinent prior art to the tremolo device of an electric guitar disclosed in the present application, or consider any cited documents as material to the patentability of the claims of the present application.

### SUMMARY

According to one aspect, there is provided a tremolo device of an electric guitar including an inertia block or tremolo bridge plate for attachment to the guitar and having a bore therethrough, an arm attached at a proximal end thereof to the inertia block or tremolo bridge plate, a potentiometer and/or a switch located at a distal end of the arm for controlling electrical functions of the guitar and/or associated amplifier, and one or more wires extending from the potentiometer and/or switch through the arm and passing through the bore of the inertia block or tremolo bridge plate for connection to circuitry within the guitar.

In one embodiment, the tremolo device further includes a casing attached to the distal end of the arm and to which the potentiometer and/or switches is/are mounted.

In one embodiment, the potentiometer and/or switches include at least one potentiometer having a shaft, and further include a knob secured to the shaft. The knob includes a shroud that extends at least partially around the casing.

According to another aspect, there is provided a combination of the tremolo device and an electric guitar to which the tremolo device is attached. The combination and an amplifier have circuitry to which the wires are electrically connected.

According to a further aspect, there is provided a tremolo assembly of an electric guitar including an inertia block coupled to a tremolo bridge plate of the guitar, an arm having a proximal end portion being coupled to the inertia block, and a potentiometer mounted at a distal end portion of the arm and electrically connected to a circuitry within the guitar for controlling electrical functions thereof. The arm includes a linear middle portion disposed generally parallel and adjacent to the guitar strings when moved towards the face of the guitar. A player can manipulate the knob of the potentiometer and produce electronic sound effects by using the hand that picks the guitar strings and controls the tremolo arm without moving the hand away from the guitar strings and the tremolo arm.

In one embodiment, the arm is in the form of a hollow tube, and one or more wires extend from the potentiometer and pass through the hollow tube.

In one embodiment, the tremolo assembly further includes a casing attached to the distal end portion of the arm, and the potentiometer is mounted to the casing.

In one embodiment, the tremolo assembly further includes a knob secured to a shaft of the potentiometer. The knob includes a shroud that extends at least partially around the casing.

In one embodiment, the casing is provided with a switch.

In one embodiment, the potentiometer is incorporated with a switch.

In one embodiment, the proximal end portion of the arm is linear and is fitted within an elongated through bore formed on the inertia block, and a central axis of the elongated through bore is disposed at an acute angle with respect to a central plane of the inertia block.

In one embodiment, the acute angle is about 10 degrees.

In one embodiment, an enlarged cutout portion is formed at an inner end of the elongated through bore.

In one embodiment, the proximal end portion of the arm is linear and is disposed at a right angle with respect to the linear middle portion.

In one embodiment, the linear middle portion of the arm is disposed at an acute angle of about 10 degrees with respect to the face of the guitar when the arm is in a rest position.

In one embodiment, the distal end portion of the arm is linear and is bent upwards away from the guitar at an acute angle of about 20 degrees and sideway towards the strings at an acute angle of about 15 degrees with respect to the linear middle portion.

In one embodiment, the tremolo assembly further includes a wireless transmitter and a battery electrically connected to the potentiometer for wireless communication with a wireless receiver electrically connected to the circuitry.

According to yet another aspect, there is provided a method of producing tremolo and electronic sound effects by an electric guitar. The method includes the steps of providing a potentiometer at a distal end portion of a tremolo arm of the guitar, the potentiometer having a shaft on which a knob is fixed, electrically connecting the potentiometer to a circuitry within the guitar, playing a note or a chord with the guitar strings, and manipulating the knob of the potentiometer to produce electronic sound effects by using the hand that picks the guitar strings and controls the tremolo arm without moving the hand away from the guitar strings and the tremolo arm.

In one embodiment, the method further includes the step of incorporating a switch with the potentiometer, electrically connecting the switch to the circuitry, and producing electronic sound effects by rotating the knob fully counter-clockwise, or pushing/pulling the knob axially to activate the switch.

In one embodiment, the method further includes the step of manipulating the tremolo arm to produce tremolo effect.

In one embodiment, the method further includes the step of manipulating the tremolo arm and the potentiometer simultaneously to produce tremolo and sound effects.

Although the tremolo device of an electric guitar disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the tremolo device of an electric guitar disclosed in the present application will now be described by way of example with reference to the accompanying drawings wherein:

FIG. 1 is a schematic plan view of a tremolo arm;

FIG. 2 is a schematic cross-sectional elevation of the tremolo arm of FIG. 1;

FIG. 3 is a schematic perspective illustration of the tremolo arm attached to an inertia block and/or tremolo bridge plate of an electric guitar;

FIG. 4 is a schematic plan view of the tremolo arm and inertia block of FIG. 3; and

FIG. 5 is a schematic elevation of the tremolo arm and inertia block of FIGS. 3 and 4.

### DETAILED DESCRIPTION

Reference will now be made in detail to a preferred embodiment of the tremolo device of an electric guitar disclosed in the present application, examples of which are also provided in the following description. Exemplary embodiments of the tremolo device of an electric guitar disclosed in the present application are described in detail, although it will be apparent to those skilled in the relevant art that some features that are not particularly important to an understanding of the tremolo device of an electric guitar may not be shown for the sake of clarity.

Furthermore, it should be understood that the tremolo device of an electric guitar disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

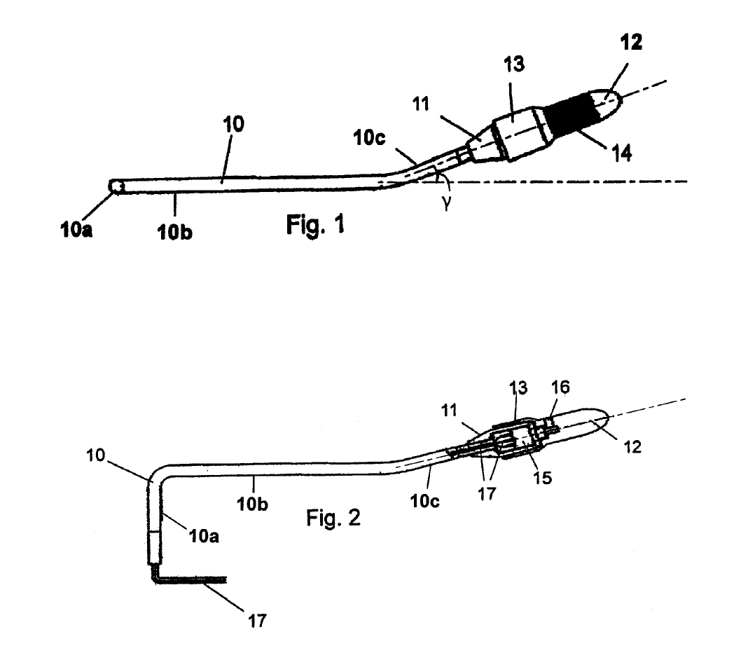

In FIG. 1, there is depicted schematically a tremolo arm 10 having a proximal end portion 10a, a middle portion 10b and a distal end portion 10c. A casing 11 may be attached or formed at the distal end portion 10c of the arm 10. As shown in FIG. 2, a potentiometer 15 may be mounted within the casing 11, although more potentiometers 15 may be provided. One or more wires 17 may be attached to the potentiometer 15. According to the illustrated embodiment, the tremolo arm 10 is in the form of a hollow tube. The wires 17 may extend from the potentiometer 15 and pass through the hollow tube.

The arm 10 may be made of metal or any other appropriate material. The casing 11 may be made of plastic by a molding process, or may be made of any other suitable material.

The potentiometer 15 has a shaft extending therefrom. A knob 12 can be affixed to the shaft of the potentiometer 15 by means of a screw 16. The knob 12 can be typically of moulded plastic material. The knob 12 may include a shroud 13 which may extend at least partially around the casing 11 and cover a portion of the casing 11. The knob 12 may typically be knurled at 14 to provide good finger grip.

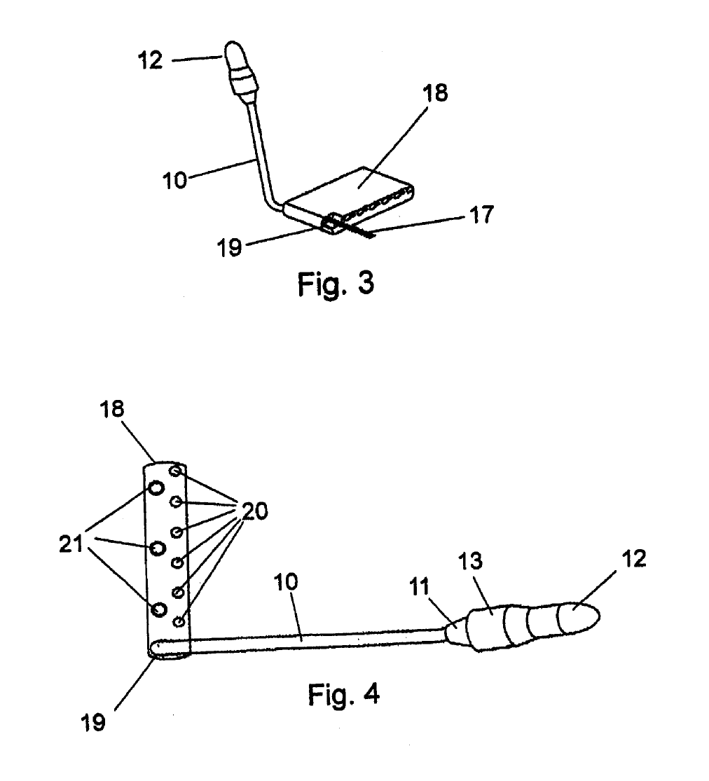

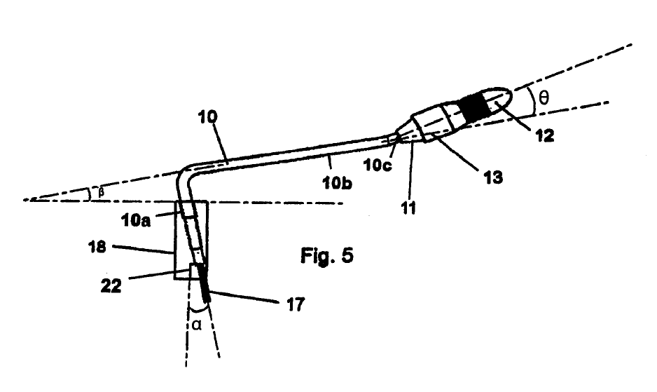

As depicted in FIGS. 3 and 4, the arm 10 can be mounted on a tremolo block or inertia block 18. The inertia block 18 is standard in that it includes an array of guitar string mounting holes 20 and screw holes 21. The inertia block 18 can be attached to or formed with a tremolo bridge plate (not shown) mounted to the string-carrying face of the guitar. A plurality of guitar strings can be held in position by a plurality of adjustable string holders respectively. The plurality of string holders can be mounted on the tremolo bridge plate. The tremolo bridge plate can pivot by means of the tremolo arm thereby varying the tension and/or length of the strings in a conventional manner to produce the desired tremolo effect.

As illustrated in FIG. 5, the proximal end portion 10a of the arm 10 can be linear and can be fitted into an elongated through bore 19 formed on the inertia block 18. The central axis of the elongated through bore 19 is disposed at an acute angle α with respect to a central longitudinal plane of the inertia block 18. The acute angle α can be about 10 degrees. This angular orientation of the proximal end portion 10a of the arm 10 can prevent the arm 10 from swinging to the bottom end of the guitar thereby keeping the arm 10 in an easy to reach position. The proximal end portion 10a can be frictionally held within the bore 19, or can be held in position by a conventional plug-in mechanism. The angular orientation of the proximal end portion 10a of the arm 10 can also prevent the arm 10 from accidentally falling out from the bore 19. Furthermore, it can allow the wires 17 extending from the lower end of the bore 19 to bend smoothly towards the guitar and amplifier circuitry within the guitar. An enlarged cutout portion 22 may be formed at the inner end of the bore 19 to facilitate a smooth wiring of the wires 17 within the guitar. The enlarged cutout portion 22 also provides a space for the wires 17 to flex freely at the inner end of the bore 19 within the guitar when the inner end of the inertia block 18 swings from side to side constantly during guitar playing. This can reduce the chance of damaging the wires 17 in the guitar.

The potentiometer 15 might include an integral switch which can be activated by turning the knob 12 fully counter-clockwise, or pulling/pushing the knob axially for example. Additional switches can be provided at the casing 11. These switches can be electrically connected to the circuitry and can be employed to control the volume and tone, or produce other sound effects.

The proximal end portion 10a of the arm 10 may be disposed at a right angle with respect to the linear middle portion 10b of the arm 10.

The linear middle portion 10b of the arm 10 may be disposed at an acute angle β of about 10 degrees with respect to the face of the guitar when the arm 10 is at a rest position. When the arm 10 is pushed towards the face of the guitar, the linear middle portion 10b arm will be disposed adjacent and parallel to the guitar strings.

The distal end portion 10c of the arm 10 may be linear and may bend upwards away from the face of the guitar at an acute angle θ of about 20 degrees and sideway towards the guitar strings at an acute angle γ of about 15 degrees with respect to the linear middle portion 10b of the arm 10.

In use, the tremolo arm 10 can be manipulated in a conventional manner. A player can play a note or chord with the guitar strings and manipulate the knob 12 of the potentiometer 15 to produce sound effects by using the hand that picks the guitar strings and controls the tremolo arm 10 without moving the hand away from the guitar strings and the tremolo arm 10. A player can produce sound effects by rotating, pushing or pulling the knob 12 to activate the switches. Furthermore, a player can manipulate the tremolo arm 10 to produce tremolo effect. A player can also manipulate the tremolo arm 10 and the knob 12 of the potentiometer simultaneously to produce tremolo and electronic sound effects.

It should be appreciated that modifications and alterations obvious to those skilled in the art are not be considered as beyond the scope of the protection. For example, rather than providing a hollow tubular arm 10, the casing 11 can be fitted with a battery and a wireless transmitter associated with the potentiometer and/or switches. Furthermore, whilst the described embodiment is an adaptation of a Fender type guitar in which the tremolo arm 10 is attached directly to the inertia block 18, the device is equally applicable to other types of guitars such as a Floyd Rose type in which the tremolo arm is fixed to a tremolo bridge plate.

While the tremolo device of an electric guitar disclosed in the present application has been shown and described with particular references to a number of preferred embodiments thereof, it should be noted that various other changes or modifications may be made without departing from the scope of the appending claims.

What is claimed is:

1. A tremolo device of an electric guitar, comprising:
(a) an inertia block or tremolo bridge plate for attachment to the guitar and having a bore therethrough;
(b) an arm attached at a proximal end thereof to the inertia block or tremolo bridge plate;
(c) a potentiometer and/or a switch located at a distal end of the arm for controlling electrical functions of the guitar and/or associated amplifier; and
(d) one or more wires extending from the potentiometer and/or switch through the arm and passing through the bore of the inertia block or tremolo bridge plate for connection to circuitry within the guitar.

2. The tremolo device as claimed in claim 1, further comprising a casing attached to the distal end of the arm and to which the potentiometer and/or switches is/are mounted.

3. The tremolo device as claimed in claim 2, wherein the potentiometer and/or switches comprise at least one potentiometer having a shaft, and further comprising a knob secured to the shaft, the knob comprising a shroud that extends at least partially around the casing.

4. In combination with the tremolo device of claim 1, an electric guitar to which the tremolo device is attached.

5. The combination of claim 4, and an amplifier having circuitry to which the wires are electrically connected.

6. A tremolo assembly of an electric guitar, comprising:
(a) an inertia block coupled to a tremolo bridge plate of the guitar;
(b) an arm having a proximal end portion being coupled to the inertia block; and
(c) a potentiometer mounted at a distal end portion of the arm and electrically connected to a circuitry within the guitar for controlling electrical functions thereof;
(d) wherein the arm comprises a linear middle portion disposed generally parallel and adjacent to the guitar strings when moved towards the face of the guitar;
(e) whereby a player can manipulate the knob of the potentiometer and produce electronic sound effects by using the hand that picks the guitar strings and controls the tremolo arm without moving the hand away from the guitar strings and the tremolo arm.

7. The tremolo assembly as claimed in claim 6, wherein the arm is in the form of a hollow tube, and one or more wires extend from the potentiometer and pass through the hollow tube.

8. The tremolo assembly as claimed in claim 6, further comprising a casing attached to the distal end portion of the arm, the potentiometer being mounted to the casing.

9. The tremolo assembly as claimed in claim 8, further comprising a knob secured to a shaft of the potentiometer, the knob comprising a shroud that extends at least partially around the casing.

10. The tremolo assembly as claimed in claim 8, wherein the casing is provided with a switch.

11. The tremolo assembly as claimed in claim 6, wherein the potentiometer is incorporated with a switch.

12. The tremolo assembly as claimed in claim 6, wherein the proximal end portion of the arm is linear and is fitted within an elongated through bore formed on the inertia block, and a central axis of the elongated through bore is disposed at an acute angle with respect to a central plane of the inertia block.

13. The tremolo assembly as claimed in claim 12, wherein the acute angle is about 10 degrees.

14. The tremolo assembly as claimed in claim 12, wherein an enlarged cutout portion is formed at an inner end of the elongated through bore.

15. The tremolo assembly as claimed in claim 6, wherein the proximal end portion of the arm is linear and is disposed at a right angle with respect to the linear middle portion.

16. The tremolo assembly as claimed in claim 6, wherein the linear middle portion of the arm is disposed at an acute angle of about 10 degrees with respect to the face of the guitar when the arm is in a rest position.

17. The tremolo assembly as claimed in claim 6, wherein the distal end portion of the arm is linear and is bent upwards away from the guitar at an acute angle of about 20 degrees and sideway towards the strings at an acute angle of about 15 degrees with respect to the linear middle portion.

18. The tremolo assembly as claimed in claim 6, further comprising a wireless transmitter and a battery electrically connected to the potentiometer for wireless communication with a wireless receiver electrically connected to the circuitry.

19. A method of producing tremolo and electronic sound effects by an electric guitar, the method comprising the steps of:
(a) providing a potentiometer at a distal end portion of a tremolo arm of the guitar, the potentiometer having a shaft on which a knob is fixed;
(b) electrically connecting the potentiometer to a circuitry within the guitar;
(c) playing a note or a chord with the guitar strings; and
(d) manipulating the knob of the potentiometer to produce electronic sound effects by using the hand that picks the guitar strings and controls the tremolo arm without moving the hand away from the guitar strings and the tremolo arm.

20. The method as claimed in claim 19, further comprising the step of incorporating a switch with the potentiometer, electrically connecting the switch to the circuitry, and producing electronic sound effects by rotating the knob fully counter-clockwise, or pushing/pulling the knob axially to activate the switch.

21. The method as claimed in claim 19, further comprising the step of manipulating the tremolo arm to produce tremolo effect.

22. The method as claimed in claim 19, further comprising the step of manipulating the tremolo arm and the potentiometer simultaneously to produce tremolo and sound effects.
